(19) United States
(12) Patent Application Publication
(10) Pub. No.: US 2011/0029617 A1
(43) Pub. Date: Feb. 3, 2011

(54) Managing Electronic Delegation Messages

(75) Inventors: Duen-wen Hsiao, Austin, TX (US); Avanish Kumar Ojha, Bangalore (IN); Muthulakshmi Pearl Srinivasan, Bangalore (IN); Satya Upadhyaya, Bangalore (IN)

Correspondence Address: IBM CORP (IBM AUSTIN IPLAW), C/O D''AMBROSIO & MENON, L.LP., 10260 WESTHEIMER ROAD, SUITE 465, HOUSTON, TX, 77042, US

(73) Assignee: International Business Machines Corporation, Armonk, NY (US)

(21) Appl. No.: 12/512,703

(22) Filed: Jul. 30, 2009

(51) Int. Cl. G06F 15/16; G06F 3/048

(52) U.S. Cl. 709/206; 715/810

(57) ABSTRACT

Methods, systems, and computer program products for managing electronic delegation messages. Embodiments of the present disclosure allow a user of an electronic messaging system to designate messages as a delegation messages. Further embodiments facilitate tracking and management of the delegation corresponding to the message. The delegation functionality may be incorporated into existing electronic messaging systems. The invention includes a method including accepting from a user a designation of an electronic message as a delegation by the user. The user may designate the electronic message as a delegation by interacting with a user interface for an electronic message system modified to recognize the designation. The electronic message may be an email message, an instant message, or a text message. The interface may be a graphical user interface. Designating the message may be accomplished by selecting an icon, entering text, and so on.

### BACKGROUND

E-mail and other types of electronic messages are often-used tools of the modern workplace. These electronic messages enable job-related communication in a convenient and reliable form. As technology becomes more integrated with day-to-day life, many users utilize electronic messages to communicate outside the workplace as well.

Users may email co-workers, customers, suppliers and others to request information or to delegate responsibility for a task. After sending such an email, the user waits for a reply. Often the same message will be sent jointly to many recipients, all of which are required to reply to the message.

### SUMMARY

Methods, systems, and computer program products for managing electronic delegation messages are disclosed herein. Delegation is a common business occurrence which is often carried out through email and other electronic message correspondence. If a reply is expected from several people to whom a task is delegated (hereinafter, “delegatees”), tracking the responsiveness of delegatees becomes difficult. Embodiments of the present disclosure allow a user of an electronic messaging system to designate messages as a delegation messages. Further embodiments facilitate tracking and management of the delegation corresponding to the message. The delegation functionality described above may be incorporated into existing electronic messaging systems.

In a first general embodiment, the invention includes a method including accepting from a user a designation of an electronic message as a delegation by the user. In specific embodiments, the user may designate the electronic message as a delegation by interacting with a user interface for an electronic message system modified to recognize the designation. The electronic message may be an email message, an instant message, or a text message. The interface may be a graphical user interface. Designating the message may be accomplished by selecting an icon, entering text, and so on.

In s second general embodiment, software modules running on a computer determine delegatees of the delegation. In specific embodiments, determining the delegatees of the delegation may be carried out by accepting a designation of the delegatees by the user; and creating a list of the designated delegatees. In other embodiments, determining the delegatees of the delegation may be carried out by creating a list of delegatees from the addressees.

In a third general embodiment, software modules (running on a computer) monitor responses to the delegation from the delegatees and determine a response status for each delegatee individually. The response status may include a responsive status, a non-responsive status, or a more fine-grained response status.

In a fourth general embodiment, the method includes presenting the response status of the delegatees to the user. The response status of the delegatees may be presented collectively or individually. The response status may be displayed in a graphical user interface using various graphical methods to differentiate between responsive and non-responsive delegatees or to summarize or present abstractions of responsive delegatees and non-responsive delegatees as a group. The presentation may be carried out within the context of the electronic messaging system or outside of the context of the electronic messaging system.

Other general embodiments include a system for electronic messaging comprising one or more data processing systems. The data processing systems comprise a processor and a computer memory operatively coupled to the processor. The computer memory of one or more of the systems have disposed within it computer program instructions for execution on the processor to implement one or more of the method embodiments described above.

The foregoing and other objects, features and advantages of the disclosure will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIGS. 1A-C illustrates a use case in accordance with one embodiment of the invention.

FIG. 2 illustrates a system for managing electronic delegation messages in accordance with one embodiment of the invention.

FIG. 3 sets forth a block diagram of an exemplary computer used in embodiments of the present disclosure.

FIG. 4 sets forth a data flow diagram illustrating a method for managing electronic delegation messages in accordance with one embodiment of the invention.

FIG. 5 sets forth an exemplary email client GUI for managing electronic delegation messages in accordance with one embodiment of the invention.

FIG. 6 sets forth an exemplary integrated collaborative system GUI for managing electronic delegation messages in accordance with one embodiment of the invention.

FIG. 7 sets forth an exemplary web-based email GUI displayed in a web browser for managing electronic delegation messages in accordance with one embodiment of the invention.

FIG. 8 sets forth an exemplary presentation of delegatees response statuses for managing electronic delegation messages in accordance with one embodiment of the invention.

### DETAILED DESCRIPTION

Exemplary methods, systems, and design structures for managing electronic delegation messages according to embodiments of the present invention are described with reference to the accompanying drawings. The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, components, acts, and equivalents of all means or step plus function elements in the claims below are intended to include any structure, material or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention and the practical application, and to enable others of ordinary skill in the art to understand the invention for various embodiments with various modifications as are suited to the particular use contemplated.

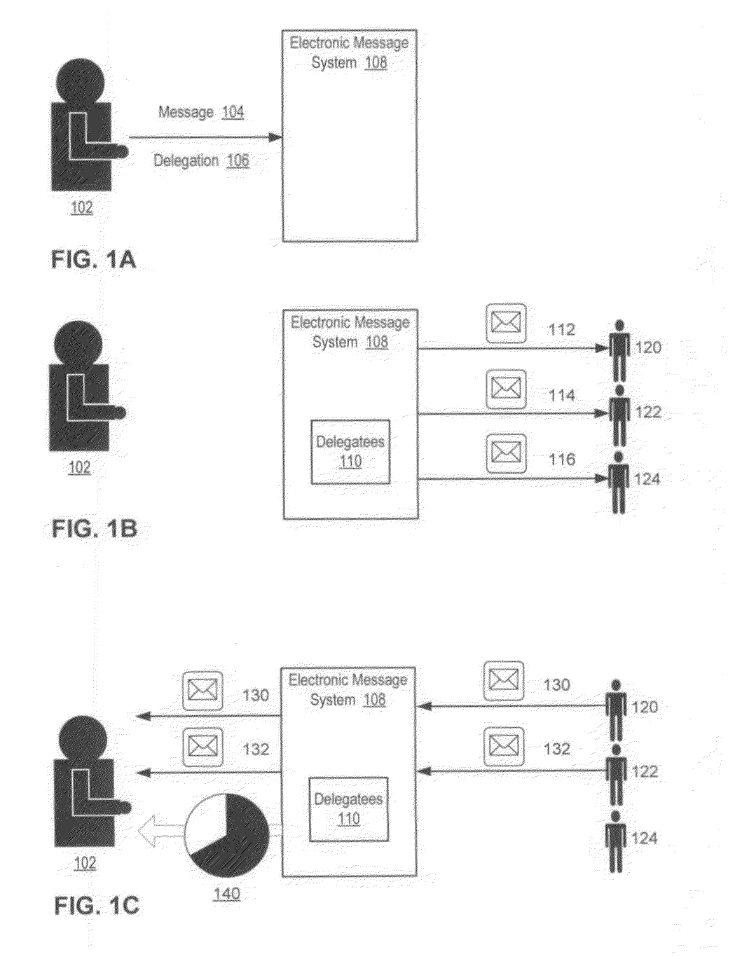

FIGS. 1A-C illustrate a use case in accordance with one embodiment of the invention. Referring to FIG. 1A, a user 102 sends an electronic message having a message component 104 and a delegation component 106 via an electronic message system 108. The electronic message may be an email message (‘email’), a textual message implemented through protocols such as the Short Message Service (‘SMS’) protocol or content implemented through the Multimedia Messaging Service (‘MMS’) (‘text messages’), an instant message sent utilizing one of various instant messaging protocols, or any other type of electronic message as will occur to those of ordinary skill in the art. The delegation component 106 is also delivered to the electronic message system 108 so that the user 102 can better manage the expected replies. The electronic message system 108 may be any electronic message system as will occur to those of skill in the art. The delegation component may be added to the electronic message by attaching the electronic delegation component or embedding the delegation component in the electronic message using various mechanisms discussed below. In some embodiments of the invention, the delegation component 106 may be sent separately from the message component 104.

In FIG. 1B, the electronic message system 108 determines the delegatees and makes a record of delegatees 110. In this case, the delegatees are the addressees of the electronic message, Alice 120. Bob 122, and Carol 124. The electronic message system 108 sends Alice 120, Bob 122, and Carol 124 each an instance of the electronic message 112, 114, and 116, respectively.

Referring to FIG. 1C, Alice 120 replies by sending a responsive message 130, and Bob 122 replies by sending a responsive message 132. Carol 124 does not reply. Responsive messages 130, 132 are delivered to the user 102 via the electronic message system 108. The electronic message system 108 monitors responses from the known delegatees 110 and presents the response status 140 of the delegatees 110 to the user 102.

The following discussion illustrates the invention through particular embodiments. Discussion of these embodiments may include elaboration in the context of email. However, embodiments of the present invention may be implemented in any form of electronic message as will occur to those of ordinary skill in the art.

E-mail (like other forms of electronic messaging) is implemented through various system architectures, such as a client-server architecture, a web-based email browser-server (Hotmail. Yahoo Mail, Google Mail, etc.), and integrated collaborative systems (Lotus Notes, Microsoft Exchange). Electronic message system 108 may include any or all of the components of any of these architectures.

Embodiments of the present disclosure include computer-implemented methods described below. In some embodiments, these methods may be carried out entirely on one apparatus or computer of the system. Alternatively, portions of the methods may be carried out on two or more computers connected by a network or a network device connecting the computers. The order of method elements as described herein does not necessarily limit the order in which the elements can be performed.

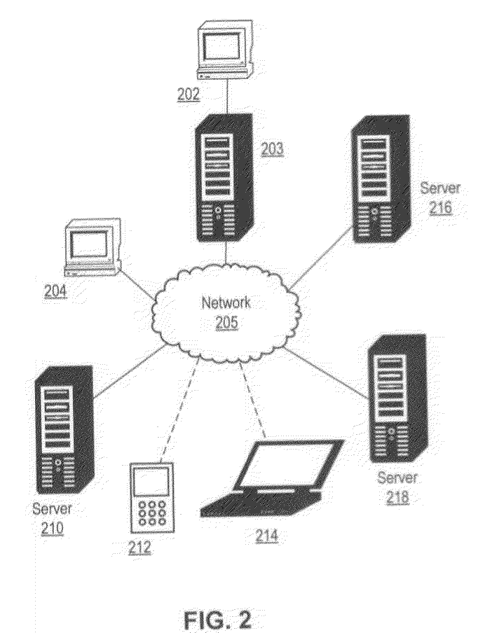

FIG. 2 illustrates a system for managing electronic delegation messages in accordance with one embodiment of the invention. The system of FIG. 2 includes a computer 204 running an email client connected through a network 205 to an email server computer 210 running an email server application. Computer 204 is a desktop computer. The client running on computer 204 formats the message in e-mail format and uses the Simple Mail Transfer Protocol (‘SMTP’) to send the message to the local mail transfer agent (‘MTA’) operating on mail server 210, such as a mail server 210 provided by an Internet Service Provider, or an MTA operating on computer 204. The MTA determines the destination address and, using the Domain Name System (‘DNS’), finds mail exchange servers that accept messages for the domain corresponding to the address. The MTA sends the message to the exchange server 316 via SMTP. The exchange server delivers it to the appropriate mailbox. Smart phone 212 and a laptop computer 214 may implement email in a similar manner by connecting wirelessly to the internet. Smart phone 212 may also receive email through carrier-based technologies. Computer 204 may also implement email by using an internet browser to communicate with a web-based email server application running on server 318.

A second desktop computer 202 is locally connected to an integrated collaborative system 203 which manages email, appointment setting, and contact information for all system users. Integrated collaborative system 203 may have an internal e-mail format and may incorporate a server having proprietary protocols. The server sends or receives e-mail through the product's Internet mail gateway which also does any necessary reformatting. Email between users using the same integrated collaborative system 203 may be implemented entirely within the system.

Network 205 may include, alone or in combination, one or more local area networks (‘LANs’), wide area networks (‘WANs’), wired or cellular telephone networks, intranets, or the Internet. Embodiments of the present invention include computer implemented methods operating on any of computer 202, 204, integrated collaborative system 203, servers 210, 216, 218, laptop computer 214, or smartphone 212, alone or in combination. Embodiments of the present disclosure may include any or all of the devices depicted in FIG. 2.

The devices disclosed in FIG. 2 are provided for illustration and not for limitation. Embodiments of the invention could be implemented as any viable computing device including logic and memory, or software modules including computer program instructions executed thereon, as will occur to one of ordinary skill in the art, including devices where logic is implemented as field-programmable gate arrays (‘FPGAs’), application-specific integrated circuits (‘ASICs’), and the like.

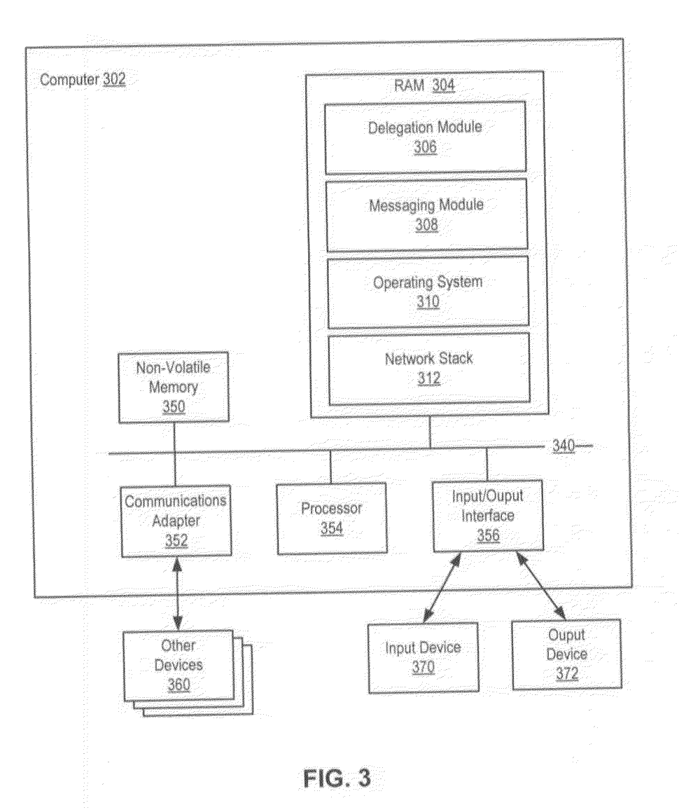

Embodiments of the presently disclosed invention are implemented to some extent as software modules installed and running on one or more data processing systems (‘computers’), such as servers, workstations, tablet computers, PCs, personal digital assistants (‘PDAs’), smart phones, and so on. Each of computer 202, 204, integrated collaborative system 203, servers 210, 216, 218, laptop computer 214, or smartphone 212 is typically implemented as a computer. FIG. 3 sets forth a block diagram of an exemplary computer used in embodiments of the present disclosure. Computer 302 includes at least one computer processor 354 as well as a computer memory, including both volatile random access memory (‘RAM’) 304 and some form or forms of non-volatile computer memory 350 such as a hard disk drive, an optical disk drive, or an electrically erasable programmable read-only memory space (also known as ‘EEPROM’ or ‘Flash’ memory). The computer memory is connected through a system bus 340 to the processor 354 and to other system components. Thus, the software modules are program instructions stored in computer memory.

An operating system 310 is stored in computer memory. Operating system 310 may be any appropriate operating system such as Windows XP, Windows Vista, Mac OS X, UNIX, LINUX, or AIX from International Business Machines Corporation (Armonk, N.Y.). A network stack 312 is also stored in memory. The network stack 312 is a software implementation of cooperating computer networking protocols to facilitate network communications.

Computer 302 also includes one or more input/output interface adapters 256. Input/output interface adapters 356 may implement user-oriented input/output through software drivers and computer hardware for controlling output to output devices 372 such as computer display screens, as well as user input from input devices 370, such as keyboards and mice.

Computer 302 also includes a communications adapter 352 for implementing data communications with other devices 360. Communications adapter 352 implements the hardware level of data communications through which one computer sends data communications to another computer through a network.

Also stored in computer memory is a messaging module 308. The messaging module 308 may include device-specific computer program instructions for implementing electronic messaging. Messaging module 308 may be implemented, in part, as a web browser or email client application running on a desktop or workstation operated by a user. Alternatively, messaging module 308 may be an integrated collaborative system application. Messaging module 308 may also be implemented, in part, as server applications running on a mail server or an application server running web-based email services. The messaging module functionality is different between different devices of FIG. 2, such as computer 202 and server 210. The messaging module 308 on servers operates to provide messaging service to multiple clients or browsers as described above with reference to FIG. 2 (e.g., determining a destination address, using DNS to find mail exchange servers, sending messages to exchange servers, etc.).

Computer memory also contains delegation module 306. Delegation module 306 comprises computer program instructions for managing electronic delegation messages according to embodiments of the disclosure. Delegation module 306 may be implemented as one or more sub-modules operating in separate software layers or in the same layer. Although depicted as a separate module from the messaging module 308 and the operating system 310, the delegation module 306 or one or more of the sub-modules may be incorporated as part of the messaging module 308, the operating system 310, or both. In various embodiments, the delegation module 306 may be implemented in the software stack or in firmware.

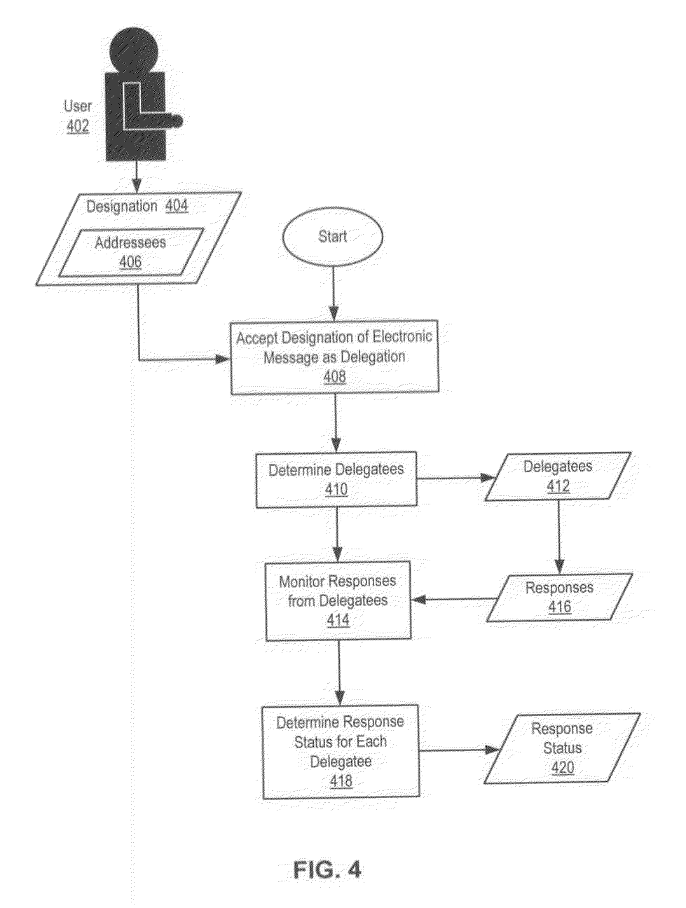

For further explanation. FIG. 4 sets forth a data flow diagram illustrating a method for managing electronic delegation messages in accordance with one embodiment of the invention. In FIG. 4, delegation module 306 accepts a designation 404 by the user of an electronic message as a delegation (block 408). The designation is initiated from the user 402. For example, an email client may accept the designation 404 through a graphical user interface (‘GUI’). A web-based email server may receive the designation 404 as input from a web browser transmitted using the Hypertext Transfer Protocol (‘HTTP’). Alternatively, an email server application may accept the designation 404 sent from an email client using the Simple Mail Transfer Protocol (‘SMTP’).

The delegation module 306 determines delegatees of the delegation. Determining the delegatees of the delegation may be carried out by accepting a designation of the delegatees from the user. For example, a list of possible names, telephone numbers, email addresses or other identifier of delegatees may be presented through a GUI and the user may select from these names by selecting or deselecting checkboxes, radio buttons, and the like or by clicking on the identifier: a user may enter an identifier of desired delegatees using a text box or a command-line interface; or a user may use a search function to identify delegatees. The delegation module 306 creates a data structure of the designated delegatees, such as a list, matrix, or table. If the delegation module 306 is remote from the user, internet communications protocols (discussed below) may be used to effect the designation. The addressees may be referred to by their address, by name, or by another identifier, or by a combination of these. The electronic message may include one or more addressees. For example, an email includes the email addresses of all the addressees. Determining the delegatees of the delegation may include creating a list of delegatees from the included addressees.

The delegation module 306 monitors responses to the delegation from the delegatees. The delegation module 306 determines a response status for each delegatee individually. The delegation module 306 may flag the entry for the delegate in the data structure when a response is detected from that delegatee, and the responses may be associated to the delegatee in the data structure as well.

Determining whether an electronic message from a delegatee is a response to the delegation may be carried out by detecting a tracking identifier or by analyzing constituent parts of the electronic message. In one implementation, the tracking identifier may be inserted in the subject line or the text of the electronic message. In other implementations, email encoding may be altered to imbed tags or identifiers specific to a particular implementation. Each delegation would be allocated its own unique identifier. This identifier may be created from information in the delegation message, such as, for example, delegatees, date, time, and subject.

For example. Internet email is typically transmitted via SMTP. Because SMTP was initially designed to support only 7-hit ASCII characters, which include only English text characters. SMTP does not transmit other types of files reliably. Multipurpose Internet Mail Extensions (MIME') format is therefore used to transmit data other than 7-hit ASCII characters as attachments. MIME defines mechanisms for sending other kinds of information in e-mail as attachments, such as, for example, text in languages other than English, text using character encodings other than ASCII, and 8-bit binary content such as files containing images, sounds, movies, and computer programs. An additional mechanism for tagging the email with an identifier or tags directing the receiving delegation module to handle the delegation according to specific preferences may be implemented using this technique.

Analyzing the constituent parts of the electronic message may vary according to the format of the electronic message. The format of Internet e-mail is defined in Request for Comments (‘RFC’) 2822, which is an updated version of RFC 822. These standards specify the formats of the email such as text email headers and body, as well as rules pertaining to commonly used header fields such as “To:”, “Subject:”. “From:”, and “Date.” This standard defines the format for the syntax and headers that make up email messages. A typical email message format consists of specific headers, with no more than one header on a line, followed by a blank line and the message body. An email message following the typical format ends with a period (‘.’) following a blank line after the message body.

Constituent parts of an email which may be analyzed include text contained in the body of the email, the sender and recipient of the email, the subject of the email as listed in the subject line, time stamps associated with the sending or receipt of the email, or any other aspects of the email as will occur to those of skill in the art. For example, the delegation module 306 may employ a series of rules which must be met for the delegatee's email to be determined to be a response to the delegation. For illustration, the rules may be that the user is an addressee of the delegatee's email, the subject of the delegatee's email is the same as the delegation email (appended prefixes and suffixes such as “RE:” notwithstanding), and substantially identical text (i.e., a string of text of at least a particular number of identical characters, after correcting for formatting) from the delegation email is contained in the delegatee's email.

Consider, for example, the following exemplary email message:

To: user@u.com
From: alice.smith@.com

### Subject: RE: Budget Estimates

My budget will be lower than last year.

### Thanks, Alice

>>From user@u.com

### >>Subject: RE: Budget Estimates

### >>Dear Alice, Bob, and Carol:

>>
>>Please respond with your budget estimates when convenient.
>>

### >>Thanks,

### >>Doug

For the exemplary email above, each rule is met. The delegating user is an addressee of the delegatee's email. After removing the appended prefix “RE:”, the subject “Budget Estimates” of the delegatee's email is the same as the delegation email, and substantially identical text from the delegation email is contained in the delegatee's email. Thus, the delegatee's email would be determined to be a response to the delegation.

The delegation module 306 presents the response status of the delegatees to the user. The delegation module 306 may also present the responses of responsive delegatees (or portions thereof) with the response status. Presenting the response status of the delegatees to the user may include presenting the response status of the users collectively or individually. For example, the presentation may include a list of the responsive or non-responsive delegatees, textual or graphical indications of the percentage, ratio, or total number of responsive or non-responsive delegatees, or a combination of these, or other information relating to the delegatees as will occur to those of skill in the art.

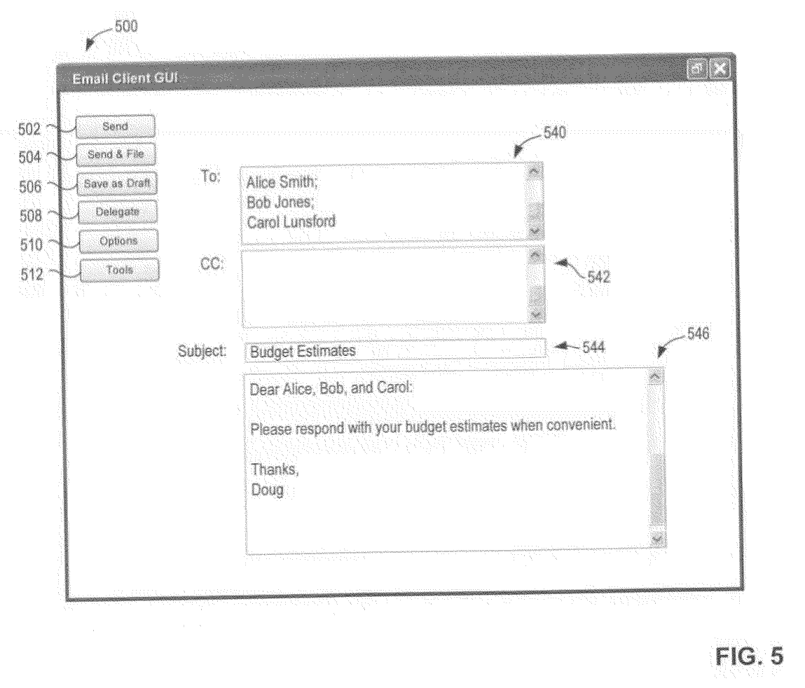

For further explanation, FIG. 5 sets forth an exemplary email client GUI for managing electronic delegation messages in accordance with one embodiment of the invention. In FIG. 5, email client GUI 500 includes a “To:” box 540 for entering and displaying addressees, a “Cc:” box 542, a “Subject:” box 544 and a text box 546 for entering the text of the email. Email client GUI 500 also includes icons for initiating actions, such as a “Send” button 502, a “Send and File” button 504, a “Save as Draft” button 506, an “Options” button 510, and a “Tools” button 512 as typically found in email client GUIs. Email client GUI 500 also includes a “Delegate” button 508. The designation of an email as a delegation (as discussed above) originates from a selection by the user of the “Delegate” button 508 within the context of the GUI, such as, for example, by navigating a cursor on the screen using a mouse until it lies over the “Delegate” button 508 and then clicking on it. The email client may use the addressees listed in the “To:” box 540 as the delegatees. In other embodiments, the present invention is implemented server-side or partially implemented on both the client and server.

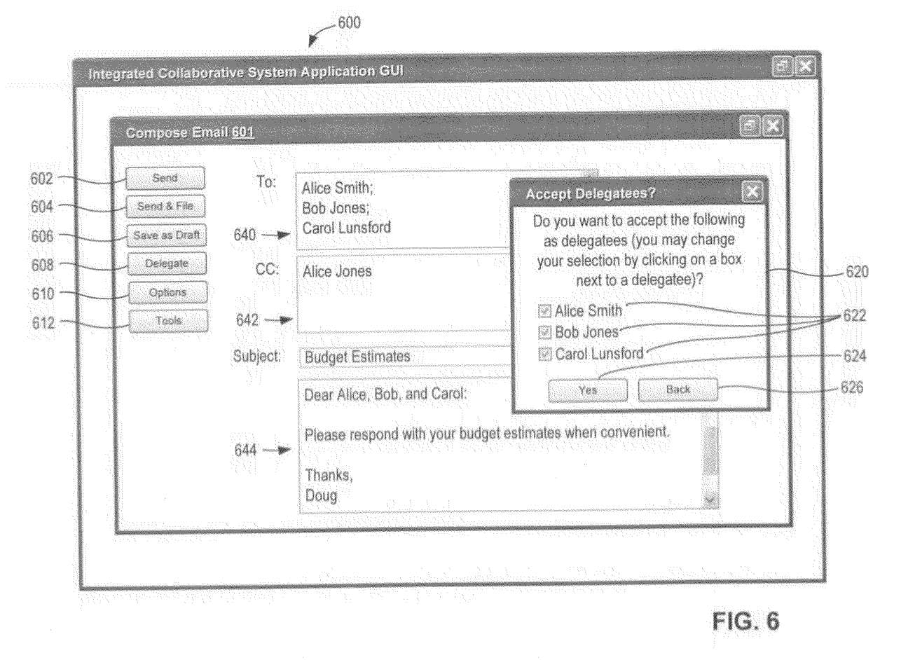

For further explanation. FIG. 6 sets forth an exemplary integrated collaborative system GUI for managing electronic delegation messages in accordance with one embodiment of the invention. In FIG. 6, integrated collaborative system GUI 600 includes an email screen 601. Email screen 601 includes a “To:” box 640 for entering and displaying addressees, a “Cc:” box 642, a “Subject:” box 644 and a text box 646 for entering the text of the email. Email screen 601 also includes icons for initiating actions, such as a “Send” button 602, a “Send and File” button 604, a “Save as Draft” button 606, an “Options” button 610, and a “Tools” button 612. Email screen 601 also includes a “Delegate” button 608. The designation of an email as a delegation (as discussed above) originates from a selection by the user of the “Delegate” button 608 within the context of the GUI as described above with reference to FIG. 5. The integrated collaborative system may enable a pop-up window 620 when the “Delegate” button 608 is selected. The pop-up window 620 may display the addressees 622 listed in the “To:” box 640 with check boxes associated with them. The user may select or de-select the checkboxes to designate the addressees as the delegatees. After making a selection, the user may accept the selection by selecting the “Yes” button 624 in the pop-up window 620. The user may return to the email and negate the delegation by selecting the “Back” button 626. In other implementations, addressees listed in the “Cc:” box may also displayed for selection and de-selection. A user may set preferences as to which addressees are displayed or selected by default. A user may also be allowed to search for addressees which are not displayed.

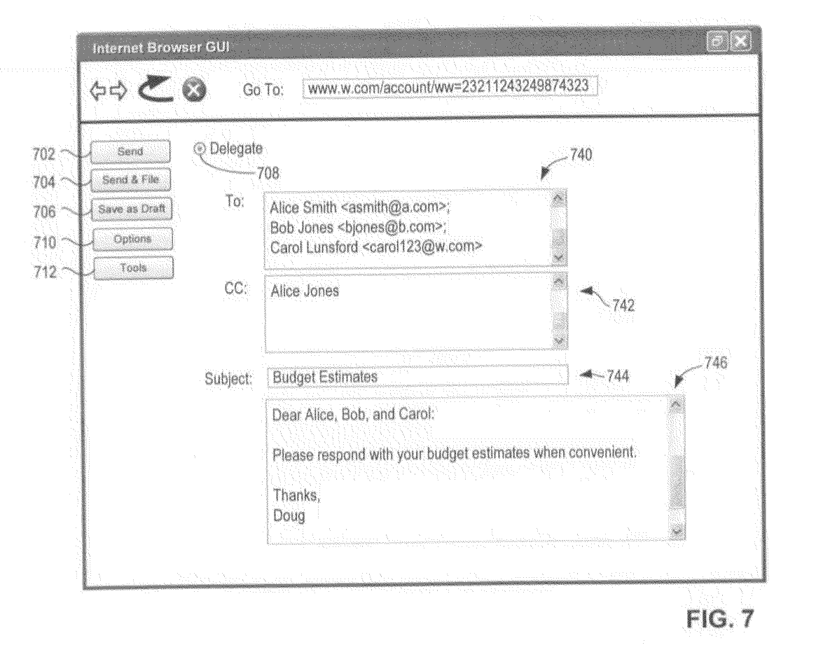

For further explanation. FIG. 7 sets forth an exemplary web-based email (‘webmail’) GUI displayed in a web browser for managing electronic delegation messages in accordance with one embodiment of the invention. In FIG. 7, webmail GUI 700 includes a “To:” box 740 for entering and displaying addressees, a “Cc:” box 742, a “Subject:” box 744 and a text box 746 for entering the text of the email. Webmail GUI 700 also includes icons for initiating actions, such as a “Send” button 702, a “Send and File” button 704, a “Save as Draft” button 706, an “Options” button 710, and a “Tools” button 712. Webmail GUI 700 also includes a “Delegate” radio button 708. A webmail server application may enable the email as a delegation when the “Send” button 702 is selected and the “Delegate” radio button 708 is in a selected state. A webmail server application may use the addressees listed in the “To:” box 740 and the “Cc:” box 742 as the delegatees. In alternative embodiments, aspects of the present disclosure may be incorporated into the web browser.

The embodiments above discuss mechanisms, such as GUI icons, that allow a user to select a message as a delegation within the context of a message composition display. In other embodiments, delegation may be determined before or after the composition display. For example, the messaging interface may provide a “Compose Message” option (such as hypertext) which leads to a traditional message composition display, and a “Compose Delegation” option.

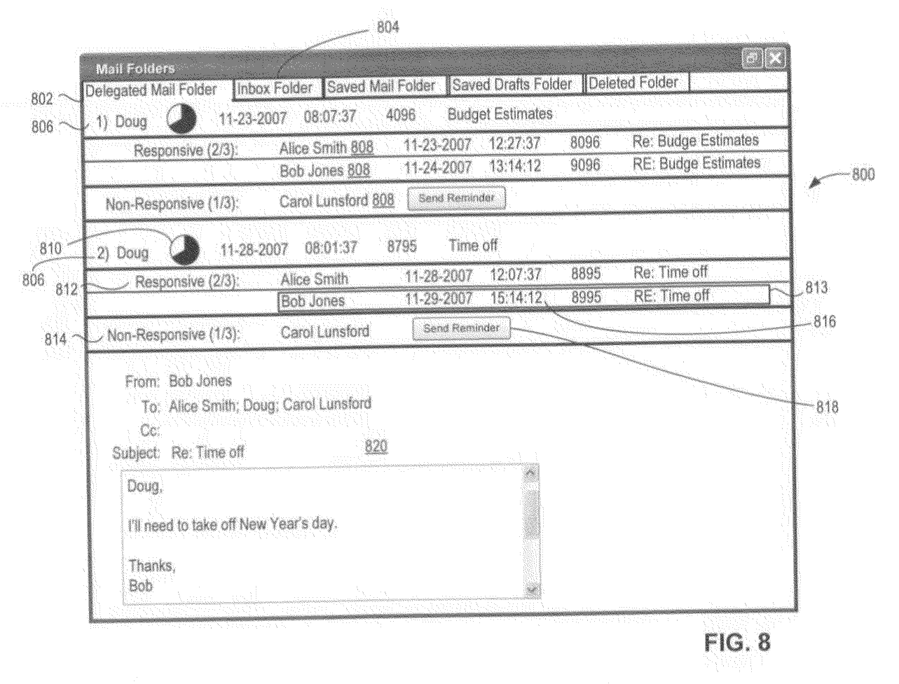

FIG. 8 sets forth an exemplary presentation of delegatees response statuses for managing electronic delegation messages in accordance with one embodiment of the invention. In FIG. 8, mail folders GUI 800 includes a delegated mail folder 802, as well as other mail folders 804. The folders may be selected using a tabbed folder metaphor (i.e., by clicking on the tab of the folder to be selected). In other embodiments, delegated mail folder 802 may be accessible using tree structures, drop down menus, special button icons, a command-line interface, etc. Delegated mail folder 802 includes a display of delegation messages 806, including a graphic 810 indicating the percentage of responsive delegatees. Each delegation message 806 is displayed with each delegatee 808 and their response status, responsive 812 or non-responsive 814. Responsive and non-responsive delegatees may be grouped together, or, in the alternative, displayed in any particular order such as, for example, the order of listing in the delegation message, an alphabetical order, priority, hierarchical order, a combination of these, and so on. Delegated mail folder 802 displays response message information 816 (date, time, unique ID, subject) in correlation with the delegate and displays the response 820 of a selected delegate 813. In other implementations, delegated mail folder 802 may display the responses of each responsive delegate (or portions thereof) in correlation with each responsive delegate. Delegated mail folder 802 also includes icons for initiating actions, such as a “Send Reminder” button 818, which may send a reminder message to one or all of the non-responsive delegatees of a delegation. This reminder message may be automatically generated or composed by a user. In some implementations, the user may configure the reminder to be sent automatically at a future time and date. In other embodiments, the response status of the delegatees may be presented as screen text only, converted to a text file, output to a report, or any other manner of presentation as will occur to those of skill in the art.

It should be understood that the inventive concepts disclosed herein are capable of many modifications. Such modifications may include combinations of hardware and software embodiments, specific circuit designs, combinations of circuits into an IC, separation of an IC into various components, and so on. To the extent such modifications fall within the scope of the appended claims and their equivalents, they are intended to be covered by this patent.

What is claimed is:

1. A computer-implemented method for managing electronic delegation messages, the method comprising:
accepting a designation of an electronic message from a user as a delegation;
determining delegatees of the delegation;
monitoring responses to the delegation from the delegatees;
determining a response status for each delegatee individually; and
presenting the response status of the delegatees to the user.

2. The method of claim 1 wherein determining the delegatees of the delegation comprises
accepting a designation of the delegatees from the user; and
creating a list of the designated delegatees.

3. The method of claim 1 wherein the electronic message comprises one or more addressees and determining the delegatees of the delegation comprises creating a record of delegatees from the addressees.

4. The method of claim 1 wherein accepting the designation of the electronic message as the delegation comprises accepting a selection by the user of a delegation icon within a graphical user interface.

5. The method of claim 1 further comprising presenting at least a portion of at least one of the responses with the response status.

6. The method of claim 1 wherein presenting the response status of the delegatees to the user comprises presenting the response status of the users collectively.

7. The method of claim 1 wherein presenting the response status of the delegatees to the user comprises presenting the response status of the users individually.

8. The method of claim 1 further comprising providing a reminder mechanism that sends a reminder to delegatees with a particular response status of unresponsive.

9. A computer program product for managing electronic delegation messages, the computer program product comprising:
a computer-readable medium having computer usable program code embodied therewith, the computer usable program code comprising:
computer program instructions for accepting a designation of an electronic message from a user as a delegation;
computer program instructions for determining delegatees of the delegation;
computer program instructions for monitoring responses to the delegation from the delegatees;
computer program instructions for determining a response status for each delegatee individually; and
computer program instructions for presenting the response status of the delegatees to the user.

10. The computer program product of claim 9 wherein computer program instructions for determining the delegatees of the delegation comprise:
computer program instructions for accepting a designation of the delegatees from the user; and
computer program instructions for creating a list of the designated delegatees.

11. The computer program product of claim 9 wherein the electronic message comprises one or more addressees and computer program instructions for determining the delegatees of the delegation comprise computer program instructions for creating a record of delegatees from the addressees.

12. The computer program product of claim 9 wherein computer program instructions for accepting the designation of the electronic message as the delegation comprise computer program instructions for accepting a selection by the user of a delegation icon within a graphical user interface.

13. The computer program product of claim 9 further comprising computer program instructions for presenting at least a portion of at least one of the responses with the response status.

14. The computer program product of claim 9 wherein computer program instructions for presenting the response status of the delegatees to the user comprise computer program instructions for presenting the response status of the users collectively.

15. The computer program product of claim 9 wherein computer program instructions for presenting the response status of the delegatees to the user comprise computer program instructions for presenting the response status of the users individually.

16. A system for managing electronic delegation messages, the system comprising:
a processor:
one or more network interfaces for receiving electronic messages; and
a computer memory operatively coupled to the processor, the computer memory having disposed within it:
computer program instructions for receiving and managing electronic messages;
computer program instructions for accepting a designation of an electronic message from a user as a delegation:
computer program instructions for determining delegatees of the delegation;
computer program instructions for monitoring responses to the delegation from the delegatees;
computer program instructions for determining a response status for each delegatee individually; and
computer program instructions for presenting the response status of the delegatees to the user.

17. The system of claim 16 wherein computer program instructions for determining the delegatees of the delegation comprise:
computer program instructions for accepting a designation of the delegatees from the user; and
computer program instructions for creating a list of the designated delegatees.

18. The system of claim 16 wherein the electronic message comprises an email message.

19. The system of claim 16 wherein the computer program instructions for receiving and managing electronic messages comprise a client application.

20. The system of claim 16 wherein the computer program instructions for receiving and managing electronic messages comprise a server application.
